(19) United States
(12) Patent Application Publication
(10) Pub. No.: US 2005/0032903 A1
(43) Pub. Date: Feb. 10, 2005

(54) Method for controlling fungal sieases in legumes

(76) Inventors: Miguel Octavio Suarez-Cervieri, Neustadt-Hambach (DE); Egon Blaich, Itapua (PY); Edson Begliomini, Sao Paulo-SP (BR); Jose Munhoz Felippe, Santos-SP (BR)

Correspondence Address: KEIL & WEINKAUF, 1350 CONNECTICUT AVENUE, N.W., WASHINGTON, DC, 20036, US

(21) Appl. No.: 10/636,600

(22) Filed: Aug. 8, 2003

(51) Int. Cl. A01N 37/18

(52) U.S. Cl. 514/620

(57) ABSTRACT

The invention relates to a method for controlling rusts in legumes, which comprises treating the aerial plant part of the legumes with an aqueous preparation of a strobilurin-containing formulation.

The invention relates to a method for controlling rust diseases in legumes.

Until recently, there was no economically important incidence of harmful fungi, such as rusts, in the main legume (in particular soybean)-producing areas. However, severe incidence of rust diseases in soybean crops caused by the harmful fungi Phakopsora pachyrhizi and Phakopsora meibomiae were observed increasingly in South America in 2001 and 2002. The results were considerable harvest and yield losses.

Most of the current fungicides are unsuitable for controlling rusts in soybeans.

Surprisingly, it has now been found that the application of an aqueous preparation of a strobilurin-containing formulation to the aerial plants—in particular leaves—of the legumes has an outstanding control effect on the abovementioned rusts.

Strobilurins which have proven particularly suitable for controlling the above-mentioned fungal diseases are dimoxystrobin, fluoxastrobin, kresoxim-methyl, metominostrobin, orysastrobin or picoxystrobin, especially preferably pyraclostrobin.

The abovementioned strobilurins are known from the literature (see www.hclrss.demon.co.uk)
dimoxystrobin, (E)-2-(methoxyimino)-N-methyl-2-[α-(2,5-xylyloxy)-o-tolyl]acetamide, disclosed in EP-A 477 631 and EP-A 398 692;
fluoxastrobin, E)-{2-[6-(2-chlorophenoxy)-5-fluoropyrimidin-4-yloxy]phenyl}(5.6-dihydro-1,4,2-dioxazin-3-yl)methanone O-methyloxime, disclosed in WO 95/04728;
kresoxim-methyl, methyl (E)-methoxyimino[α-(o-tolyloxy)-o-tolyl]acetate, disclosed in EP 253 213;
metominostrobin, (E)-2-(methoxyimino)-N-methyl-2-(2-phenoxyphenyl)-acetamide, disclosed in EP-A 398 692;
orysastrobin, (2E)-2-(methoxyimino)-2-(2-[(3E,5E,6E)-5-(methoxyimino)-4,6-dimethyl-2,8-dioxa-3,7-diazanona-3,6-dien-1-yl]phenyl)N-methylacetamide, disclosed in WO-A 97115552;
picoxystrobin, methyl (E)-3-methoxy-2-{2-[6-(trifluoromethyl)-2-pyridyloxy-methyl]phenyl}acrylate, disclosed, for example, in EP 278595
pyraclostrobin, methyl N-{2-[1-(4-chlorophenyl)-1H-pyrazol-3-yloxymethyl]-phenyl}(N-methoxy)carbamate, disclosed, for example, in EP 804 421

The strobilurins not only have an outstanding anti-rust effect, but they also increase the yield capacity of the legumes. The term legumes covers the following crop plants:
peas, beans, lentils, peanuts, lupins and, in particular, soybeans. Increased yields which are not attributed to the fungicidal effect of the strobilurins have already been reported in connection with the use of strobilurins in cereals (Koehle H. et al, in Gesunde Pflanzen 49 (1997), pages 267-271; Glaab J. et al. Planta 207 (1999), 442-448).

When using strobilurins, in particular pyraclostrobin, the dramatically increased yields in soybeans are surprising. The increased yield potential in combination with the outstanding anti-rust effect of the strobilurins in legumes make the method according to the invention particularly interesting for the farmer. Outstanding results can be achieved when using pyraclostrobin.

The method according to the invention furthermore also demonstrates very good control on other harmful fungi which are frequently found in legumes. The most important fungal diseases in soybeans are listed hereinbelow:
Microsphaera diffusa
Cercospora kikuchi
Cercospora sojina
Septoria glycines
Colletotrichum truncatum

The strobilurins are also suitable for controlling the abovementioned diseases. However, the strobilurins may also be present together with other active ingredients, such as, for example, the herbicides, insecticides, growth regulators, fungicides or else with fertilizers. Mixing the strobilurins, or the compositions comprising them, in the use form as fungicides with other fungicides results in a widened fungicidal spectrum of action in many cases.

The following list of fungicides together with which the compounds of the invention can be employed are intended to illustrate the possible combinations, but not to limit them:
acylalanines such as benalaxyl, metalaxyl, ofurace, oxadixyl,
amine derivatives such as aldimorph, dodine, dodemorph, fenpropimorph, fenpropidin, guazatine, iminoctadine, spiroxamin, tridemorph
anilinopyrimidines such as pyrimethanil, mepanipyrim or cyrodinyl,
antibiotics such as cycloheximide, griseofulvin, kasugamycin, natamycin, polyoxine or streptomycin,
azols such as bitertanol, bromoconazole, cyproconazole, difenoconazole, dinitroconazole, epoxiconazole, fenbuconazole, fluquiconazole, flusilazole, hexaconazole, imazalil, metconazole, myclobutanil, penconazole, propiconazole, prochloraz, prothioconazole, tebuconazole, triadimefon, triadimenole, triflumizole, triticonazole,
dicarboximides such as iprodion, myclozolin, procymidon, vinclozolin,
dithiocarbamates such as ferbam, nabam, maneb, mancozeb, metam, metiram, propineb, polycarbamate, thiram, ziram, zineb,
heterocyclic compounds such as anilazine, benomyl, boscalid, carbendazim, carboxin, oxycarboxin, cyazofamid, dazomet, dithianon, famoxadon, fenamidon, fenarimol, fuberidazole, flutolanil, furametpyr, isoprothiolan, mepronil, nuarimol, probenazol, proquinazid, pyrifenox, pyroquilon, quinoxyfen, silthiofam, thiabendazole, thifluzamid, thiophanate-methyl, tiadinil, tricyclazole, triforine,
copper fungicides such as Bordeaux mixture, copper acetate, copper oxychloride, basic copper sulfate,
nitrophenyl derivatives such as binapacryl, dinocap, dinobuton, nitrophthal-isopropyl
phenylpyrroles such as fenpiclonil or fludioxonil,
sulfur,
other fungicides such as acibenzolar-S-methyl, benthiavalicarb, carpropamid, chlorothalonil, cyflufenamid, cymoxanil, dazomet, diclomezin, diclocymet, diethofencarb, edifenphos, ethaboxam, fenhexamid, fentin-acetate, fenoxanil, ferimzone, fluazinam fosetyl, fosetyl-aluminum, iprovalicarb, hexachlorobenzene, metrafenon, pencycuron, propamocarb, phthalide, toloclofos-methyl, quintozene, zoxamid
strobilurins such as azoxystrobin, dimoxystrobin, fluoxastrobin, kresoxim-methyl, metominostrobin, orysastrobin, picoxystrobin, pyraclostrobin or trifloxystrobin,
sulfenic acid derivatives such as captafol, captan, dichlofluanid, folpet, tolylfluanid, cinnamamides and analogs such as dimethomorph, flumetover or flumorph.

Mixtures which have been proved very particularly suitable for the method according to the invention are mixtures of strobilurins with an azole, such as, for example, bromoconazole, cyproconazole, epoxiconazole, fenbuconazole, fluquiconazole, flusilazole, metconazole, myclobutanil, propiconazole, prochloraz, prothioconazole, tebuconazole or triticonazole. Especially preferred is the mixture of pyraclostrobin and epoxyconazole.

The strobilurins are applied by treating the fungi, or the plants, materials or the soil to be protected from fungal disease, with a fungicidally active amount of the active ingredients. Part of the legumes which are treated with an aqueous preparation of the active ingredient are, in particular, the aerial plant parts, in particular the leaves. Application may be effected both before and after infection of the materials of plants by the fungi.

In general, the fungicidal compositions comprise between 0.1 and 95, preferably 0.5 and 90, % by weight of active ingredient.

When used in crop protection, the rates of application are from 0.01 to 2.0 kg of active ingredient per ha, depending on the nature of the effect desired.

In the treatment of seed, amounts of active ingredient of from 0.001 to 0.1 g, preferably 0.01 to 0.05 g, are generally required per kilogram of seed.

The strobilurins can be converted into the customary formulations, e.g. solutions, emulsions, suspensions, dusts, powders, pastes and granules. The use form depends on the particular purpose; it is intended to ensure in each case a fine and uniform distribution of the compound according to the invention,

The formulations are prepared in a known manner, e.g. by extending the active ingredient with solvents and/or carriers, if desired using emulsifiers and dispersants. Solvents/auxiliaries which are suitable are essentially.
water, aromatic solvents (for example Solvesso products, xylene), paraffins (for example mineral fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used.
carriers such as ground natural minerals (e.g. kaolins, clays, talc, chalk) and ground synthetic minerals (e.g. highly disperse silica, silicates); emulsifiers such as nonionic and anionic emulsifiers (e.g. polyoxyethylene fatty alcohol ethers, alkylsulfonates and arylsulfonates) and dispersants such as lignin-sulfite waste liquors and methylcellulose.

Suitable surfactants are alkali metal, alkaline earth metal and ammonium salts of lignosulfonic acid, naphthalenesulfonic acid, phenolsulfonic acid, dibutyinaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, strongly polar solvents, for example dimethyl sulfoxide, N-methylpyrrolidone and water.

Powders, materials for spreading and dusts can be prepared by mixing or concomitantly grinding the active substances with a solid carrier.

Granules, for example coated granules, impregnated granules and homogeneous granules, can be prepared by binding the active ingredients to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active ingredient. The active ingredients are employed in a purity of from 90% to 100%, preferably 95% to 100% (according to NMR spectrum).

The following are examples of formulations:

1. Products for Dilution with Water

A Soluble Concentrates (SL)

10 parts by weight of a compound according to the invention are dissolved in water or in a water-soluble solvent. As an alternative, wetters or other auxiliaries are added. The active ingredient dissolves upon dilution with water.

B Dispersible Concentrates (DC)

20 parts by weight of a compound according to the invention are dissolved in cyclohexanone with addition of a dispersant, for example polyvinylpyrrolidone. Dilution with water gives a dispersion.

C Emulsifiable Concentrates (EC)

15 parts by weight of a compound according to the invention are dissolved in xylene with addition of calcium dodecylbenzenesulfonate and castor oil ethoxylate (in each case 5% strength). Dilution with water gives an emulsion.

D Emulsions (EW, EO)

40 parts by weight of a compound according to the invention are dissolved in xylene with addition of calcium dodecylbenzenesulfonate and castor oil ethoxylate (in each case 5% strength). This mixture is introduced into water by means of an emulsifier (Ultraturrax) and made into a homogeneous emulsion. Dilution with water gives an emulsion.

E Suspensions (SC, OD)

In an agitated ball mill, 20 parts by weight of a compound according to the invention are comminuted with addition of dispersant, wetters and water or an organic solvent to give a fine active ingredient suspension, Dilution with water gives a stable suspension of the active ingredient.

F Water-Dispersible Granules and Water-Soluble Granules (WG, SG)

50 parts by weight of a compound according to the invention are ground finely with addition of dispersants and wetters and made into water-dispersible or water-soluble granules by means of technical appliances (for example extrusion, spray tower, fluidized bed). Dilution with water gives a stable dispersion or solution of the active ingredient.

G Water-Dispersible Powders and Water-Soluble Powders (WP, SP)

75 parts by weight of a compound according to the invention are ground in a rotor-stator mill with addition of dispersant, wetters and silica gel. Dilution with water gives a stable dispersion or solution with the active ingredient.

2. Products to be Applied Undiluted

H Dustable Powders (DP)

5 parts by weight of a compound according to the invention are ground finely and mixed intimately with 95% of finely divided kaolin. This gives a dustable product.

I Granules (GR, FG, GG, MG)

0.5 part by weight of a compound according to the invention is ground finely and associated with 95.5% carriers. Current methods are extrusion, spray-drying or the fluidized bed. This gives granules to be applied undiluted.

J ULV Solutions (UL)

10 parts by weight of a compound according to the invention are dissolved in an organic solvent, for example xylene. This gives a product to be applied undiluted.

The active ingredients can be used as such, in the form of their formulations or the use forms prepared therefrom, e.g. in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; it is intended to ensure in each case the finest possible distribution of the active ingredients according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active ingredient concentrations in the ready-to-use products can be varied within relatively wide ranges. In general, they are from 0.0001 to 10%, preferably from 0.01 to 1%.

The active ingredients may also be used successfully in the ultra-low-volume process (ULV), it being possible to apply formulations comprising over 95% by weight of active ingredient, or even to apply the active ingredient without additives.

Various types of oils, wetters, adjuvants, herbicides, fungicides, other pesticides, or bactericides may be added to the active ingredients, if appropriate just immediately prior to use (tank mix). These agents can be admixed with the agents according to the invention in a weight ratio of 1:10 to 10:1.

### USE EXAMPLE

During the pod-filling phase, soybean plants cv. “RS 10” with a foliar Phakopsora pachyrhizi disease level of 8-12% were sprayed, in field trials in Brazil, with a mixture consisting of 4.6 g/ha epoxiconazole and 12.2 g/ha pyraclostrobin in 200 l of water/ha, using equipment conventionally used in practice. 12 days after the treatment, the disease on the untreated, but infected, leaves had developed to such an extent that 83% of the leaf area was affected. In the plots treated with the above-described mixture, however, infection with Phakopsora pachyrhizi had only reached a level of 25%. This reduced disease level, together with the yield-increasing properties of the strobilurins, in the present case pyraclostrobin, resulted in a yield increase of 53% in comparison with the yield of the uncreated control.

1. A method for controlling rust diseases in legumes, which comprises treating the aerial plant part of the legumes with an aqueous preparation of a strobilurin-containing formulation.

2. The method as claimed in claim 1, wherein rust diseases on the leaves of soybean plants are controlled.

3. The method as claimed in claim 1, wherein the rust disease is caused by Phakopsora pachyrhizi or Phakopsora meibomiae.

4. The method as claimed in claim 1 any of claims 1 to 3, wherein a fungicide selected from the group of the strobilurin fungicides such as dimoxystrobin, fluoxastrobin, kresoxim-methyl, metominostrobin, orysastrobin, picoxystrobin or pyraclostrobin is employed.

5. The method as claimed in claim 4, wherein pyraclostrobin is employed as strobilurin.
